(19) United States
(12) Patent Application Publication
(10) Pub. No.: US 2007/0156426 A1
(43) Pub. Date: Jul. 5, 2007

(54) Internally unique referencing for correlation

(76) Inventors: Thomas Hoffmann, Romerberg (DE); Dietmar Nowotny, Dielheim (DE)

Correspondence Address: SCHWEGMAN, LUNDBERG, WOESSNER & KLUTH, P.A., P.O. BOX 2938, MINNEAPOLIS, MN, 55402, US

(21) Appl. No.: 11/322,462

(22) Filed: Dec. 30, 2005

(51) Int. Cl. G06Q 99/00

(52) U.S. Cl. 705/1; 705/26

(57) ABSTRACT

A method of identifying transactions in a value chain involves representing multiple business documents associated with a value chain with unique internal representations. In one embodiment, a contract is represented with a first unique internal representation, a purchase order is represented with a second unique internal representation, and an invoice is represented with a third unique internal representation. In a further embodiment, business partner communications are correlated to one of the internal representations to identify a corresponding value chain.

### BACKGROUND

In business management systems, there may be multiple different referencing mechanisms for documents associated with transactions. Different documents, such as contracts and invoices may be referenced in different manners by different portions of the business management system. This can lead to processes disruptions, reconciliation problems, and difficulty in correlating transactions with each other.

### SUMMARY

A method of identifying transactions in a value chain involves representing multiple business documents associated with a value chain with unique internal representations. In one embodiment, a contract is represented with a first unique internal representation, a purchase order is represented with a second unique internal representation, and an invoice is represented with a third unique internal representation. In a further embodiment, business partner communications are correlated to one of the internal representations to identify a corresponding value chain.

### BRIEF DESCRIPTION OF THE DRAWINGS

FIG. 1 is a block diagram illustration of a value chain with prima nota and single point inventory objects according to an example embodiment.

FIG. 2 is a flow chart illustrating updating of inventory objects according to an example embodiment.

FIG. 3 is a flow chart illustrating component operations in a value chain of components according to an example embodiment.

FIG. 4 is a flow chart illustrating cancellation of a transaction according to an example embodiment.

FIG. 5 is a flow chart illustrating identification of a value chain by the use of multiple internal unique reference numbers according to an example embodiment.

FIG. 6 is a flow chart illustrating a general method of matching payments with outstanding invoices according to an example embodiment.

FIG. 7 is a flow chart illustrating the use of a string search on concatenated data according to an example embodiment.

FIG. 8 is a diagram illustrating an invoice database and corresponding concatenated data with example search string according to an example embodiment.

FIG. 9 is a block diagram of a computer system for implementing methods of the present invention according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description is, therefore, not to be taken in a limited sense, and the scope of the present invention is defined by the appended claims.

The functions or algorithms described herein are implemented in software or a combination of software and human implemented procedures in one embodiment. The software consists of computer executable instructions stored on computer readable media such as memory or other type of storage devices. The term “computer readable media” is also used to represent any means by which the computer readable instructions may be received by the computer, such as by different forms of electromagnetic transmissions. Further, such functions correspond to modules, which are software, hardware, firmware or any combination thereof. Multiple functions are performed in one or more modules as desired, and the embodiments described are merely examples. The software is executed on a digital signal processor, ASIC, microprocessor, or other type of processor operating on a computer system, such as a personal computer, server or other computer system.

A business operations management system manages transactions, such as transactions related to a customer order in a value chain. Each transaction is assigned an internally unique reference number. Three such transactions are linked to each other, such as a contract, an order, and an invoice. Communications with business partners may include a form of identification different from the internally unique reference numbers. Such different identifications may be correlated to one or more of the internally unique reference numbers to ensure that such communications are properly managed with respect to the transactions. The internally unique reference numbers may be globally unique identifiers (GUIDs), and thus not customer friendly. The reference number may also be any type of unique alphanumeric string, and not just composed of integers.

As correspondence is received from the customer, a transformation may be used to identify at least one of the three internally unique reference numbers. In some embodiments, there may be many of one type of transaction that are related or linked to one of another type of transaction, such as the case of a contract having multiple orders, or an order or contract corresponding to multiple invoices. One payment may apply to multiple invoices.

When sending an invoice or delivering an order, an external representation may be used that is easier for a business partner to understand or process correctly. When the customer replies, the reply is transformed to at least one of the internal representations of the transactions in the value chain to match it to the proper transaction. Fuzzy searching may be used to aid in such matching.

Internal representations are unique, and internally known in one embodiment. A GUID may be used if desired, or any other mechanism that provides a unique and internally known number.

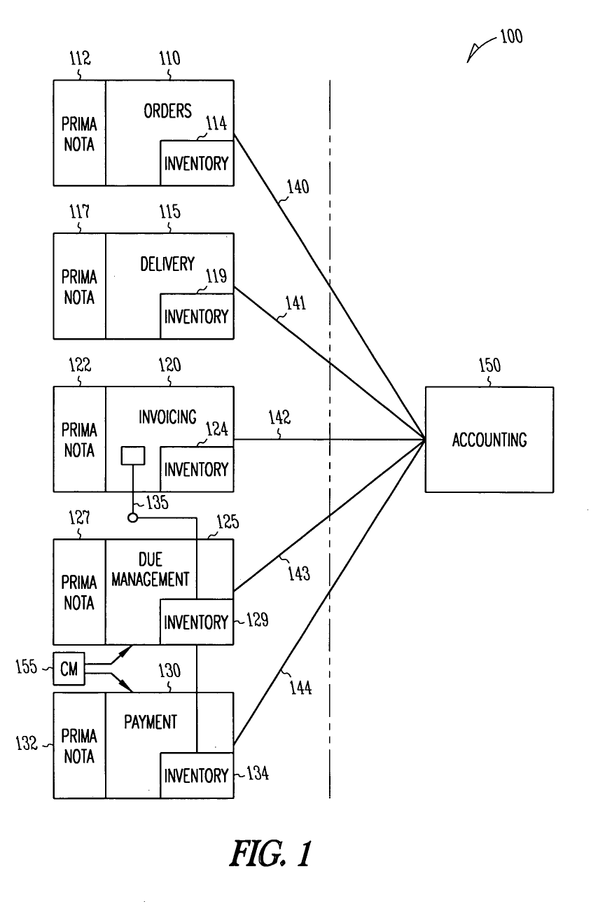

FIG. 1 is a block diagram illustration of a value chain 100 with prima nota and single point inventory objects according to an example embodiment. Selected components in the value chain comprise an orders component, 110, a delivery component 115, an invoicing component 120, a due management component 125 and a payment component 130. Orders component 110 may include prima nota 112 and an order inventory object 114. The prima nota 112 consists of images of original business documents, such as actual customer orders and contracts in one embodiment. These are the original business documents, and in one embodiment, are assigned a unique internal identification or representation such as a string of numbers and/or characters, to ensure proper referencing. While such prima nota 112 are the primary business documents, copies of them may be provided if desired.

Order inventory object 114 may include an inventory of all current unshipped orders in one embodiment. It is updated by the use of messages generated as a result of transactions. A transaction may be performed by the orders component 110 in response to receipt of an order. A message to update the inventory object 114 may also result from a delivery transaction via delivery component 115.

Deliver component 115 may also include prima nota 117 that contains primary business documents, such as delivery documents, and a delivery inventory 119, which again may be updated via messages generated by transactions from one or more components.

Invoicing component 120 may also include prima nota 122 that contains primary copies of invoices and other business documents related to functions that the invoicing component 120 performs. Invoicing component 120 may not contain a separate inventory object. It reuses the inventory of the due management component 129. Transactions may result in increases and reductions in the inventory of inventory object 129.

Due management component 125 may also include prima nota 127, such as documents related to amounts due from business partners, collections notices, etc. Due management component 125 may also include a due inventory object that represents amounts due from business partners. It may be updated via messages resulting from transactions in various components, such as invoicing via the invoicing component as represented by line 135. It may also be updated by messages generated from payments received via payment component 130.

Payment component 130 may also include prima nota 132, such as documents related to payments. Payments may take many different forms, such as cash, check, money order, credit card, offsets, and electronic funds transfer. The prima nota may be scanned copies of checks, or associated communications with such payments. The payments are transactions that are processed by the payment component 130 and result in messages incrementing and decrementing a payment register inventory object 134.

In one embodiment, the components perform transactions that modify one or more inventory objects, and also may result in communications of such transactions in the form of messages as indicated at 140, 141, 142, 143 and 144 being sent to a separate accounting/finance system 150. The business operations 100 and accounting/finance system 150 are separate systems that communicate back and forth via messages. In one embodiment, the business operations system 100 is a cash based system, where cash is calculated in real time. The accounting system may operate on an accrual basis. By using messages between these two different systems, and keeping business documents and inventory separate in the operations system, each system is free to select how to handle transactions.

One result of this separation is that a cash management function 155, which may not be associated with any of the listed components, may quickly obtain information on the overall cash position of a business implemented by the components. Two inventory objects, the due management inventory object 129 and the payment register inventory object 134 contain representations of a substantial percentage of the cash position of the business. In one embodiment, it is approximately 80% of the cash position of the business. Thus, in a simple operation involving only two messages to these inventory objects, a good indication of the cash position of the business is easily obtained.

FIG. 2 is a flow chart illustrating updating of inventory objects according to an example embodiment. At 210, payments due are tracked in a single point of inventory payments due inventory object. Transactions resulting in payments due, such as the creation and sending of an invoice to a business partner result in updating of the payments due inventory object. Such updates are caused by messages that are received by the object and invoke methods on the object to increment or decrement payments due. Further methods may be used to obtain totals from the inventory object. In one embodiment, such totals are representative of the cash represented in the object.

At 220, payments received are tracked in a single point of inventory payment registry inventory object. As the payments are received by a component, messages are generated to increment or decrement the inventory payment registry inventory object. Such payments may be payments in full, or partial payments, and the inventory object is modified correspondingly. Further methods may be used to obtain totals from the inventory object. In one embodiment, such totals are representative of the cash represented in the object.

At 230, such updating of the payments due inventory object and the payment registry received inventory object is done via messages generated in response to transactions. As indicated above, the transactions may be related to invoices being generated, and invoices being paid partially or fully. In further embodiments, components may send messages resulting from transactions to the separate accounting system, which may be based on a different accounting method.

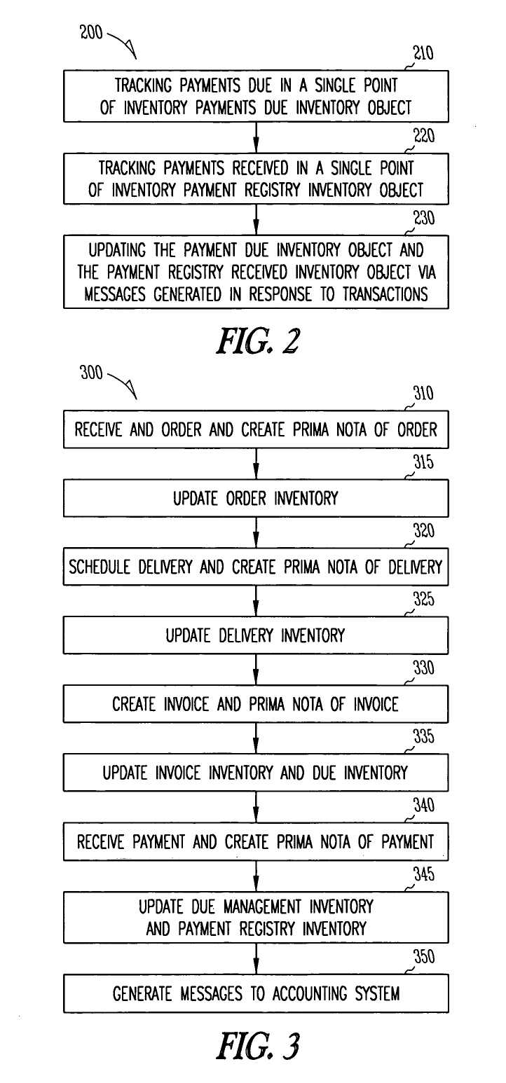

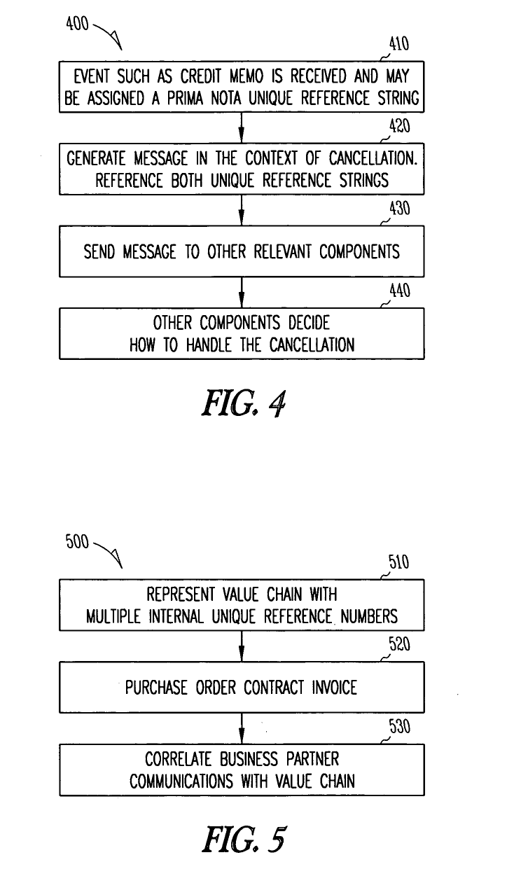

FIG. 3 is a flow chart illustrating component operations in a value chain of components according to an example embodiment. At 310, an order is received and prima nota of the order may be created. The prima nota may consist of a scanned or electronic copy of the order in one embodiment. At 315, the order inventory may be updated. At 320, a delivery of the order may be scheduled, and prima nota of delivery documents may be created. At 325, the delivery inventory may be updated. At 330, an invoice and prima nota for the invoice may be created. The due inventory may be updated at 335. When payment is received, prima nota of payment may be created, and at 345, due management inventory and payment registry inventory may be updated. Messages to the accounting system may be generated as a result of selected transactions at 350.

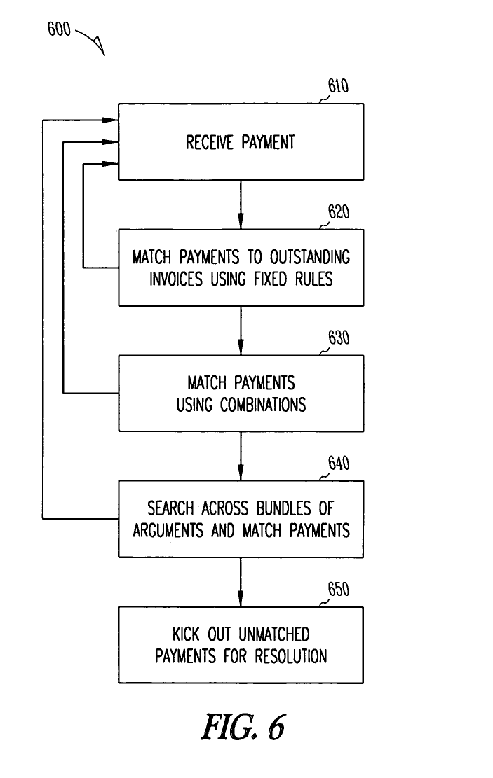

One example of a complete cancellation involves the receipt of a full credit memo that clearly cancels an invoice, as illustrated in a process 400 flowchart in FIG. 4. As indicated above, the prima nota for the invoice is identified by a unique reference string. The credit memo is received at 410, and may be assigned a prima nota internally unique reference number or string, which is different from the invoice prima nota. The credit memo in one embodiment is just one event that may be detected that results in a cancellation of the invoice. Other events may result in full cancellation of an invoice, or other type of transaction. At 420, a message is generated in the context of cancellation. The message may reference both of the unique reference strings or identifiers of the invoice prima nota and the credit memo prima nota. The message is sent to other relevant components at 430. As other components, such as due management component 125 and accounting system 150 may have created secondary documents based on the original invoice, the unique references to the prima nota invoice and credit memo allows the receiving entity or component to connect the secondary documents to the prima nota, and to decide how to handle the cancellation on their own at 440.

This capability can be helpful when dealing with the independent accounting system 150. In one example, an invoice may be posted in the accounting system 150 in December, and the books may be closed by the time a cancellation occurs in January. It would not be helpful to have the component on the business operations side that received the cancellation indicate how the accounting system 150 should handle the cancellation. It may not be possible to reopen the books from December. The method of sending a message that uniquely identifies prima nota from the operations side enables the accounting system to precisely identify the business transactions and potential related secondary documents that it has created, and then decide how to handle the cancellation. It may result in the books being reopened or restated, or it may just be entered into the books in January. The handling of such a cancellation may also be performed according to individual business conditions or rules.

In one embodiment, cancellation are performed on primae noate only. They create a new prima nota unique reference number and reference back to the prima nota which was cancelled. Messages carrying cancellations work by reference, so that no values are transported redundantly. The receiver is free to choose the appropriate strategy to cancel its data, such as the cancellation of accounting documents in closed periods, entries in trade receivables/payables may be cancelled by undoing a clearing and canceling of the original entry. Due management may reopen an already cleared item before canceling it. More flexibility is provided to the receiving components in handling the cancellation.

The components form a value chain in one embodiment that corresponds to a plurality of transactions with a business partner. In one embodiment indicated at 500 in FIG. 5, multiple internal unique reference numbers are used to represent the value chain at 510. Multiple prima nota or documents are used to uniquely identify all transactions in one value chain as indicated at 520. A contract is represented with a first unique internal representation. A purchase order is represented with a second unique internal representation, and an invoice is represented with a third unique internal representation. In some embodiments, a purchase order need not be generated, but a simple order may be used.

Business partner communications may be correlated to one or more of the internal unique representations at 530. Multiple invoices may be linked to a single contract or invoice. The business partner communication may also be a payment, or a shipment received from the business partner. A method is provided for correlating business partner communications with corresponding documents in the value chain, without requiring the business partner to utilize the internally unique representations.

FIG. 6 is a flowchart providing an overview of a process 600 for clearing received payments at 610 against outstanding invoices. This is just one example of business partner communications that may be correlated to the value chain. Other example include, but are not limited to customer orders, delivery confirmations, change orders, credit memos and other correspondence that may be received from a business partner and affect transactions conducted with respect to a value chain. This is also just one example of various methods that may be used to correlate business partner correspondence with the value chain. Other methods that are capable of identifying or correlating at least one of the internal unique references numbers corresponding to the value chain may also be used.

In the example of FIG. 6, payments may come in many different forms, including but not limited to checks, cash, money transfer, cashier's check, electronic fund transfer, offsets against amounts owed, and other methods. Each payment may be reviewed by a person and either entered in a computer system or processed by the person. Electronic payments may be directly stored in the computer system without human intervention. With this great variety of payment methods, there may be many different ways of correlating a payment with a unique internal reference number for a value chain. Perhaps the easiest way involves the use of fixed rules at 620

One fixed rule comprises comparing an invoice identifier, such as an alphanumeric character string or number associated with the payment, such as one written on a received check, or on correspondence accompanying the payment with an outstanding invoice number. The invoice number may be a number, such as a series of consecutive numbers used to identify an invoice to a business partner. The invoice number is likely different than the unique internal reference number, but is associated with the unique internal reference number for the invoice prima nota. If the invoice number on the payment matches the invoice number, it is likely that the payment should be correlated to the invoice and by association, the corresponding value chain. Another fixed rule might be that if only one invoice is outstanding from a customer or business partner, and a payment is received from the customer, the payment relates to the corresponding value chain set of internal unique reference numbers. There are many other fixed rules that may be easily addressed in the same manner.

If application of the fixed rules do not match a payment to an invoice or value chain, a second method involving combinations of matches may be used. This may involve combinations of matches of database fields, such as customer and amount, if the amount is unique for that customer. In other words, if a customer has two invoices outstanding, with one for 40 and another for 66, and the payment received is for 66, then it is highly likely that the payment is for the 66 invoice, even if no invoice number was included with the payment. Many such combinations of fields may be used to correctly correlate a payment with an invoice, and hence the value chain.

If the above methods still result in a payment not being associated with a value chain, a further method involves the use of a search string at 640. In the fuzzy search, the fields or arguments of each record in the invoice database are concatenated, and a search string may be applied against these bundles of arguments. If there are 10 fields, for example in an invoice database, which includes at least one of the internal reference numbers for each value chain, the bundling of the records allows the use of standard search tools, such as searchable strings. The strings may include data included with a payment, and may allow the use of a fuzzy search. A fuzzy search may return results even when the string does not precisely correlate with the record. In one example, an invoice number may have two digits transposed. If one or more other selected arguments in the record match the data associated with the payment, the payment may be cleared against the corresponding invoice.

At each of the above methods, 620, 630 and 640, payments may be matched and associated, and the next payment may be processed at 610. If none of the methods correlate a payment to an invoice and hence a value chain, the payment may be kicked out at 650 as an unmatched payment and sent to another process for resolution. Such a process may be a human or a computer implemented method.

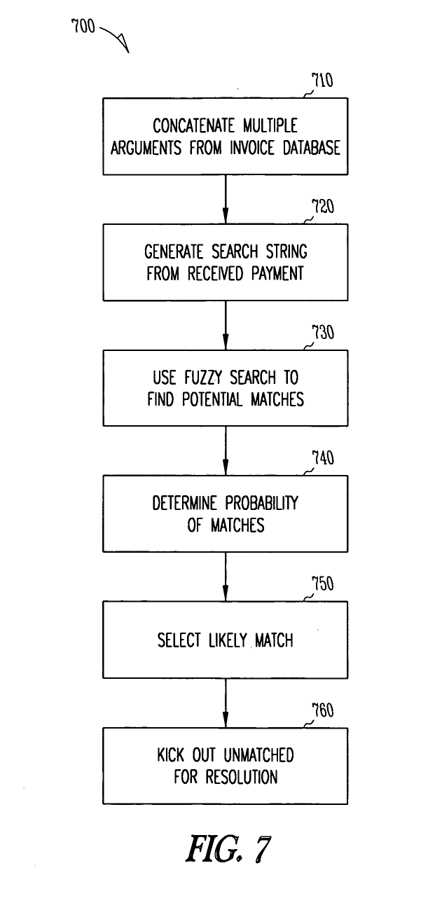

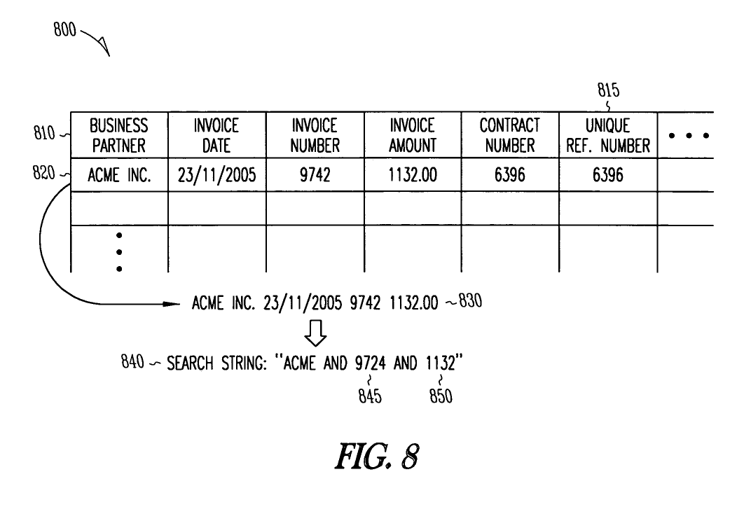

Further detail of the use of search strings for searching an invoice database is illustrated at 700 in FIG. 7. At 710, multiple arguments from the invoice database are concatenated to provide bundles of arguments that are searchable. Each record in one embodiment is formed into such a bundle by concatenation of the fields. Fields in one embodiment may include, but are not limited to business partner or customer name, invoice date, invoice number, invoice amount, contract number, contacts, address, etc., and at least one of the unique internal reference numbers for each corresponding value chain.

At 720, a search string is generated from information associated with a payment. The information may be information on a check, a cover letter, text associated with an electronic transfer, or other forms information that may be associated with a payment. The search string may be a Boolean logic string that may be created in multiple different manners. It may also be written in SQL, or other search language.

The search string is applied against the bundles of arguments using common search techniques at 730. In one embodiment, a fuzzy search is applied. The search may return one or more matches with varying probabilities of each match corresponding to the payment at 740. A likely match may be selected automatically from such matches at 750. If no matches are likely, it may be kicked out for further resolution at 760.

FIG. 8 illustrates an example abbreviated database at 800. The database comprises multiple fields, which correspond to columns of an invoice database as indicated 810. Such columns correspond to information associated with each invoice, such as business partner name, invoice date, invoice number, invoice amount, contract number, etc. These are just a few examples of the potential fields or columns of an invoice database. The invoice number and contract number in this example may be numbers used in external communications, such as to a business partner. In addition, one or more internal unique reference numbers are included, such as the reference number for an invoice prima nota, order prima nota, and/or contract prima nota as represented at 815. A single record is shown at 820 for Acme Inc. Each of the fields is populated with data if available.

The fields of each record are concatenated, or placed end to end in a single text string as indicated at 830 for the Acme Inc. record 820. This is also referred to as bundling of arguments in one embodiment. A search string generated from a payment and associated information is shown at 840. To illustrate the fuzzy nature of a search, two digits of the invoice number, which is “9742” in the database, are transposed in the payment information to read “9724” in the search string 840. The search string contains a matching business partner name and invoice amount, and so it returns the Acme Inc record corresponding to invoice 9742 as a high percentage, if not 100% match. In other words, the matching of multiple fields, combined with what appears to be a typographical error in the invoice number lead to a high probability that the correct invoice to apply the payment to has been found. In addition, the record identified as a match contains the internal unique reference number corresponding to the correct value chain. In this case, that number is “1X3ZA29 . . .”. As indicated previously, such unique numbers are not amenable for external use due to some of the attributes that make them unique. Such attributes may appear to make them random and long, leading to likely errors by business partners in entering them and using them on return correspondence. This highlights the need for simpler numbers to use in correspondence with business partners, or the external invoice number in this example.

The search string in combination with the bundled records, allows a much more flexible and robust set of common search tools to be used in attempts to find matches. The percentage likelihood of the above match may be increased if no other similar records were found, or if other found records had a much lower probability of matching. Further, if two fields or information from a payment were transposed, such as mixing up the contract number and the invoice number, the search would still find the corresponding invoice. This would not likely occur in prior field based searching methods.

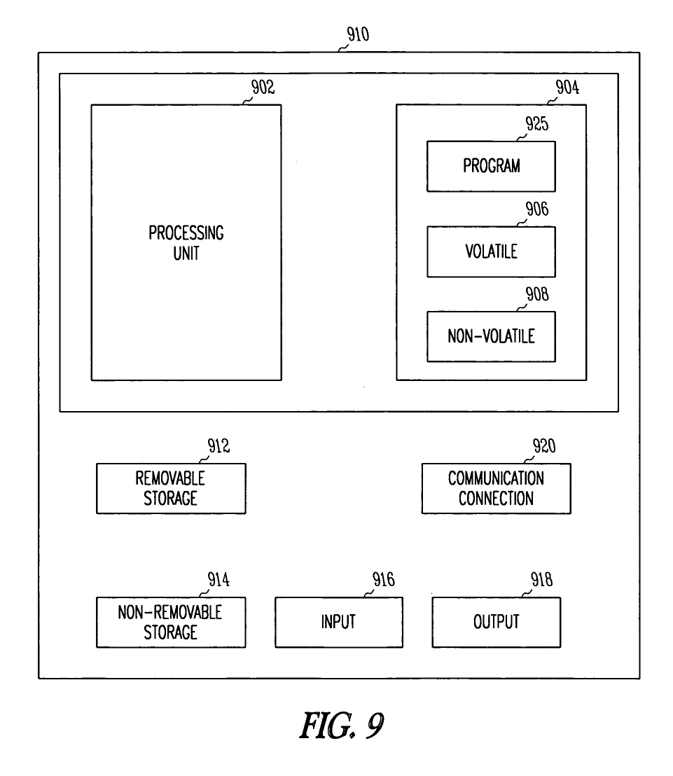

A block diagram of a computer system that executes programming for performing the above functions is shown in FIG. 9. In one embodiment, multiple such computer systems are utilized in a distributed network to implement multiple components in a transaction based environment. An object oriented architecture may be used to implement such functions and communicate between the multiple systems and components. One example computing device in the form of a computer 510, may include a processing unit 502, memory 504, removable storage 912, and non-removable storage 914. Memory 904 may include volatile memory 906 and non-volatile memory 908. Computer 910 may include—or have access to a computing environment that includes—a variety of computer-readable media, such as volatile memory 906 and non-volatile memory 908, removable storage 912 and non-removable storage 914. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 910 may include or have access to a computing environment that includes input 916, output 918, and a communication connection 920. The computer may operate in a networked environment using a communication connection to connect to one or more remote computers, such as database servers. The remote computer may include a personal computer (PC), server, router, network PC, a peer device or other common network node, or the like. The communication connection may include a Local Area Network (LAN), a Wide Area Network (WAN) or other networks.

Computer-readable instructions stored on a computer-readable medium are executable by the processing unit 902 of the computer 910. A hard drive, CD-ROM, and RAM are some examples of articles including a computer-readable medium. The term “computer readable medium” is also used to represent electromagnetic transmission of the software. For example, a computer program 925 capable of providing a generic technique to perform access control check for data access and/or for doing an operation on one of the servers in a component object model (COM) based system according to the teachings of the present invention may be included on a CD-ROM and loaded from the CD-ROM to a hard drive. The computer-readable instructions allow computer 910 to provide generic access controls in a COM based computer network system having multiple users and servers.

The Abstract is provided to comply with 37 C.F.R. §1.72(b) to allow the reader to quickly ascertain the nature and gist of the technical disclosure. The Abstract is submitted with the understanding that it will not be used to interpret or limit the scope or meaning of the claims.

1. A method of identifying transactions in a value chain, the method comprising:
representing a contract with a first unique internal representation;
representing a purchase order with a second unique internal representation; and
representing an invoice with a third unique internal representation.

2. The method of claim 1 and further comprising correlating business partner communications to one of the internal representations.

3. The method of claim 2 wherein the business partner communication comprises a payment.

4. The method of claim 2 wherein the business partner communication comprises a shipment received from the business partner.

5. The method of claim 1 wherein multiple invoices may be linked to a single contract.

6. The method of claim 1 wherein multiple payments may be linked to a single invoice.

7. The method of claim 1 wherein the order comprises a purchase order, and where multiple purchase orders may be linked to a single contract.

8. The method of claim 2 wherein fuzzy logic is used to correlate the business partner communications to one of the internal representations.

9. The method of claim 1 wherein the unique internal representation comprises a globally unique identification.

10. The method of claim 9 wherein communications to a business partner does not contain a unique internal representation.

11. The method of claim 1 wherein the contract, order and invoice are linked.

12. The method of claim 11 and further comprising performing a search on information in communications from a business partner to correlate them to at least one of the contract, order and invoice.

13. The method of claim 12 wherein the search comprises a fuzzy search.

14. The method of claim 12 wherein the contract, order and invoice comprise prima nota.

15. A computer readable medium having instructions for causing a computer to execute a method of identifying transactions in a value chain, the method comprising:
representing a contract with a first unique internal representation;
representing a purchase order with a second unique internal representation; and
representing an invoice with a third unique internal representation.

16. The computer readable medium of claim 15 wherein the method further comprises correlating business partner communications to one of the internal representations.

17. The computer readable medium of claim 16 wherein the business partner communication comprises a payment.

18. A system that identifies transactions in a value chain, the system comprising:
a representation of a contract with a first unique internal reference;
a representation of an order with a second unique internal reference; and
a representation of an invoice with a third unique internal reference.

19. The system of claim 18 and further comprising means for correlating business partner communications to one of the internal representations.

20. The system of claim 19 wherein the business partner communication comprises a payment.
